(19) United States
(12) Patent Application Publication
(10) Pub. No.: US 2024/0336516 A1
(43) Pub. Date: Oct. 10, 2024

(54) Privacy Glass

(71) Applicant: Vitro Flat Glass LLC, Cheswick, PA (US)

(72) Inventors: José Guadalupe Cid-Aguilar, Monterrey (MX); Melanie Almaraz-Caballero, Guadalupe (MX); José Luis Colunga-Gonzalez, Escobedo (MX)

(21) Appl. No.: 18/624,718

(22) Filed: Apr. 2, 2024

Related U.S. Application Data
(60) Provisional application No. 63/594,720, filed on Oct. 31, 2023.
(60) Provisional application No. 63/457,274, filed on Apr. 5, 2023.

(51) Int. Cl. C03C 4/02; B32B 17/10; C03B 18/02; C03C 3/078; C03C 3/087; C03C 17/00

(52) U.S. Cl. CPC C03C 4/02; B32B 17/10036; B32B 17/1011; B32B 17/10119; B32B 17/10449; C03B 18/02; C03C 3/078; C03C 3/087; C03C 17/002; B32B 2419/00; B32B 2605/00; C03C 2204/00

(57) ABSTRACT

The present invention relates to privacy glass and to methods of making the same. In particular, the invention relates to privacy glass for use in vehicle windows and various other applications including, but not limited to, architectural applications, produced by float processes.

### CROSS-REFERENCE TO RELATED APPLICATION

The present application is claims priority to, and is a non-provisional of, U.S. Provisional Patent Application No. 63/457,274, filed Apr. 5, 2023, and U.S. Provisional Patent Application No. 63/594,720, filed Oct. 31, 2023, the disclosures of which are hereby incorporated by reference in their entireties.

### BACKGROUND OF THE INVENTION

### Field of the Invention

The present invention relates to privacy glass and to methods of making the same. In particular, the invention relates to privacy glass for use in vehicle windows and various other applications including, but not limited to, architectural applications, produced by float processes.

### Description of the Related Art

Various types of privacy glasses are known in the art. While various glass color profiles and light transmittance properties are available, none to date have been able to realize a glass composition that has both a very low level of light transmittance in combination with a desirable color profile.

### SUMMARY OF THE INVENTION

The invention relates to a glass having a visible light transmission (“T_{LA}”) of greater than 0 percent and equal to or less than 8 percent at a glass thickness of 3.85 mm via T_{LA} CIE Ilum “A” across wavelengths 380 nm to 780 nm, an a* in the range of −8 to 4.5, and a b* in the range of −12.5 to 15.5.

The invention further relates to a method of making a glass by, among other things, providing a glass batch that has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm, an a* in the range of −6 to 4, or an a* in the range of −5 to 1, or even an a* in the range of −4.5 to 0.5, and a b* in the range of −5.5 to 12.5, or a b* in the range of −2 to 6, or even a b* in the range of 0 to 5.

Further non-limiting embodiments or aspects are set forth and described in the following clauses.

Clause 1: A glass comprising 64 to 75 weight percent SiO₂; 10 to 20 weight percent Na₂O; 5 to 15 weight percent CaO; 0 to 5 weight percent MgO; 0 to 3 weight percent Al₂O₃; 0 to 3 weight percent K₂O; 0 to 1 weight percent SO₃ (or even 0.1 to 0.35 weight percent SO₃); and 1.65 to 3 weight percent total iron, preferably 1.7 to 2.4 weight percent total iron, or even more preferably greater than 2.0 to 2.15 weight percent total iron, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5).

Clause 2: The glass of clause 1, wherein the glass comprises a redox ratio of at least 0.12 and at most 0.32.

Clause 3: The glass of any of clauses 1 or 2, wherein the glass comprises a redox ratio of at least 0.16 and at most 0.26, or even a redox of at least 0.17 and at most 0.25.

Clause 4: The glass of any of clauses 1 to 3, further comprising 0.044 to 0.059 weight percent CoO.

Clause 5: The glass of any of clauses 1 to 3, further comprising 0.0465 to 0.0565 weight percent CoO.

Clause 6: The glass of any of clauses 1 to 3, further comprising 0.049 to 0.054 weight percent CoO.

Clause 7: The glass of any of clauses 1 to 6, further comprising 0.004 to 0.02 weight percent selenium, preferably 0.005 to 0.018 weight percent selenium, or even more preferably 0.006 to 0.008 weight percent selenium.

Clause 8: The glass of any of clauses 1 to 7, further comprising 0.0005 to 0.07 weight percent Cr₂O₃, preferably 0.0009 to 0.06 weight percent Cr₂O₃, or even more preferably 0.001 to 0.05 weight percent Cr₂O₃, or even more preferably 0.038 to 0.044 weight percent Cr₂O₃. In another instance, the glass comprises 0.01 to 0.04 weight percent Cr₂O₃.

Clause 9: The glass of any of clauses 1 to 8, further comprising 0.0005 to 0.03 weight percent CuO, preferably 0.0015 to 0.025 weight percent CuO, or even more preferably 0.002 to 0.02 weight percent CuO.

Clause 10: The glass of any of clauses 1 to 9, further comprising 0.01 to 0.5 weight percent TiO₂, preferably 0.02 to 0.25 weight percent TiO₂, or even more preferably 0.03 to 0.1 weight percent TiO₂.

Clause 11: The glass of any of clauses 1 to 10, wherein the glass has a neutral color as determined by the naked eye.

Clause 12: The glass of any of clauses 1 to 11, wherein the glass has a T_{UV} of less than 8 percent at a glass thickness of 3.85 mm, or preferably the glass has a T_{UV} of less than 6 percent at a glass thickness of 3.85 mm, or even more preferably the glass has a T_{UV} of less than 4 percent at a glass thickness of 3.85 mm.

Clause 13: The glass of any of clauses 1 to 12, wherein the glass has a visible light transmission (“T_{LA}”) of less than 5 percent at a glass thickness of 3.85 mm, or preferably the glass has a visible light transmission (“T_{LA}”) of less than 4.5 percent at a glass thickness of 3.85 mm, or even more preferably the glass has a visible light transmission (“T_{LA}”) of less than 4 percent at a glass thickness of 3.85 mm.

Clause 14: The glass of any of clauses 1 to 13, wherein the glass has a Solar Direct Transmittance (Te) of less than 12 percent at a glass thickness of 3.85 mm, or preferably the glass has a Solar Direct Transmittance (Te) of less than 11 percent at a glass thickness of 3.85 mm, or even more preferably the glass has a Solar Direct Transmittance (Te) of less than 10 percent at a glass thickness of 3.85 mm.

Clause 15: The glass of any of clauses 1 to 14, wherein the glass is used in one or more of an architectural transparency or a vehicle transparency.

Clause 16: The glass of any of clauses 1 to 14, wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

Clause 17: A method of making a glass using a conventional float non-vacuum glass system, comprising melting a glass batch to provide a pool of molten glass; flowing the pool of molten glass onto a molten tin bath; moving the molten glass on the surface of the molten tin bath, while controllably cooling the molten glass and applying forces to the molten glass to provide a glass of a desired thickness; and removing the glass from the molten tin bath, wherein the glass comprises 64 to 75 weight percent SiO₂; 10 to 20 weight percent Na₂O; 5 to 15 weight percent CaO; 0 to 5 weight percent MgO; 0 to 3 weight percent Al₂O₃; 0 to 3 weight percent K₂O; 0 to 1 weight percent SO₃ (or even 0.1 to 0.35 weight percent SO₃); and 1.65 to 3 weight percent total iron expressed as Fc203, preferably 1.7 to 2.4 weight percent total iron, or even more preferably greater than 2.0 to 2.15 weight percent total iron, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5).

Clause 18: The method of clause 17, wherein the glass comprises a redox ratio of at least 0.12 and at most 0.32.

Clause 19: The method of any of clauses 17 or 18, wherein the glass comprises a redox ratio of at least 0.16 and at most 0.26, or even a redox of at least 0.17 and at most 0.25.

Clause 20: The method of any of clauses 17 to 19, wherein the glass further comprises 0.044 to 0.059 weight percent CoO.

Clause 21: The method of any of clauses 17 to 19, wherein the glass further comprises 0.0465 to 0.565 weight percent CoO.

Clause 22: The method of any of clauses 17 to 19, wherein the glass further comprises0.049 to 0.054 weight percent CoO.

Clause 23: The method of any of clauses 17 to 22, wherein the glass further comprises 0.004 to 0.02 weight percent selenium, preferably 0.005 to 0.018 weight percent selenium, or even more preferably 0.006 to 0.008 weight percent selenium.

Clause 24: The method of any of clauses 17 to 23, wherein the glass further comprises 0.0005 to 0.07 weight percent Cr₂O₃, preferably 0.0009 to 0.06 weight percent Cr₂O₃, or even more preferably 0.001 to 0.05 weight percent Cr₂O₃, or even more preferably 0.038 to 0.044 weight percent Cr₂O₃. In another instance, the glass comprises 0.01 to 0.04 weight percent Cr₂O₃.

Clause 25: The method of any of clauses 17 to 24, wherein the glass further comprises 0.0005 to 0.03 weight percent CuO, preferably 0.0015 to 0.025 weight percent CuO, or even more preferably 0.002 to 0.02 weight percent CuO.

Clause 26: The method of any of clauses 17 to 25, wherein the glass further comprises 0.01 to 0.5 weight percent TiO₂, preferably 0.02 to 0.25 weight percent TiO₂, or even more preferably 0.03 to 0.1 weight percent TiO₂.

Clause 27: The method of any of clauses 17 to 26, wherein the glass has a neutral color as determined by the naked eye.

Clause 28: The method of any of clauses 17 to 27, wherein the glass has a T_{UV} of less than 8 percent at a glass thickness of 3.85 mm, or preferably the glass has a T_{UV} of less than 6 percent at a glass thickness of 3.85 mm, or even more preferably the glass has a T_{UV} of less than 4 percent at a glass thickness of 3.85 mm.

Clause 29: The method of any of clauses 17 to 28, wherein the glass has a visible light transmission (“T_{LA}”) of less than 5 percent at a glass thickness of 3.85 mm, or preferably the glass has a visible light transmission (“T_{LA}”) of less than 4.5 percent at a glass thickness of 3.85 mm, or even more preferably the glass has a visible light transmission (“T_{LA}”) of less than 4 percent at a glass thickness of 3.85 mm.

Clause 30: The method of any of clauses 17 to 29, wherein the glass has a Solar Direct Transmittance (Te) of less than 12 percent at a glass thickness of 3.85 mm, or preferably the glass has a Solar Direct Transmittance (Te) of less than 11 percent at a glass thickness of 3.85 mm, or even more preferably the glass has a Solar Direct Transmittance (Te) of less than 10 percent at a glass thickness of 3.85 mm.

Clause 31: A laminate comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; and an interlayer positioned between the first ply and the second ply, wherein at least one of the first ply or second ply is formed from a glass comprising 64 to 75 weight percent SiO₂; 10 to 20 weight percent Na₂O; 5 to 15 weight percent CaO; 0 to 5 weight percent MgO; 0 to 3 weight percent Al₂O₃; 0 to 3 weight percent K₂O; 0 to 1 weight percent SO₃ (or even 0.1 to 0.35 weight percent SO₃); and 1.65 to 3 weight percent total iron expressed as Fe₂O₃, preferably 1.7 to 2.4 weight percent total iron, or even more preferably greater than 2.0 to 2.15 weight percent total iron, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5).

Clause 32: The laminate of clause 31, wherein the glass comprises a redox ratio of at least 0.12 and at most 0.32.

Clause 33: The laminate of any of clauses 31 or 32, wherein the glass comprises a redox ratio of at least 0.16 and at most 0.26, or even a redox of at least 0.17 and at most 0.25.

Clause 34: The laminate of any of clauses 31 to 33, wherein the glass further comprises 0.044 to 0.059 weight percent CoO.

Clause 35: The laminate of any of clauses 31 to 33, wherein the glass further comprises 0.0465 to 0.565 weight percent CoO.

Clause 36: The laminate of any of clauses 31 to 33, wherein the glass further comprises 0.049 to 0.054 weight percent CoO.

Clause 37: The laminate of any of clauses 31 to 36, wherein the glass further comprises 0.004 to 0.02 weight percent selenium, preferably 0.005 to 0.018 weight percent selenium, or even more preferably 0.006 to 0.008 weight percent selenium.

Clause 38: The laminate of any of clauses 31 to 37, wherein the glass further comprises 0.0005 to 0.07 weight percent Cr₂O₃, preferably 0.0009 to 0.06 weight percent Cr₂O₃, or even more preferably 0.001 to 0.05 weight percent Cr₂O₃, or even more preferably 0.038 to 0.044 weight percent Cr₂O₃. In another instance, the glass comprises 0.01 to 0.04 weight percent Cr₂O₃.

Clause 39: The laminate of any of clauses 31 to 38, wherein the glass further comprises 0.0005 to 0.03 weight percent CuO, preferably 0.0015 to 0.025 weight percent CuO, or even more preferably 0.002 to 0.02 weight percent CuO.

Clause 40: The laminate of any of clauses 31 to 39, wherein the glass further comprises 0.01 to 0.5 weight percent TiO₂, preferably 0.02 to 0.25 weight percent TiO₂, or even more preferably 0.03 to 0.1 weight percent TiO₂.

Clause 41: The laminate of any of clauses 31 to 40, wherein the glass has a neutral color as determined by the naked eye.

Clause 42: The laminate of any of clauses 31 to 41, wherein the glass has a T_{UV} of less than 8 percent at a glass thickness of 3.85 mm, or preferably the glass has a T_{UV} of less than 6 percent at a glass thickness of 3.85 mm, or even more preferably the glass has a T_{UV} of less than 4 percent at a glass thickness of 3.85 mm.

Clause 43: The laminate of any of clauses 31 to 42, wherein the glass has a visible light transmission (“T_{LA}”) of less than 5 percent at a glass thickness of 3.85 mm, or preferably the glass has a visible light transmission (“T_{LA}”) of less than 4.5 percent at a glass thickness of 3.85 mm, or even more preferably the glass has a visible light transmission (“T_{LA}”) of less than 4 percent at a glass thickness of 3.85 mm.

Clause 44: The laminate of any of clauses 31 to 43, wherein the glass has a Solar Direct Transmittance (Te) of less than 12 percent at a glass thickness of 3.85 mm, or preferably the glass has a Solar Direct Transmittance (Te) of less than 11 percent at a glass thickness of 3.85 mm, or even more preferably the glass has a Solar Direct Transmittance (Te) of less than 10 percent at a glass thickness of 3.85 mm.

Clause 45: The laminate of any of clauses 31 to 44, wherein both the first ply and the second ply are formed from glasses having the composition of any of clauses 31 to 44.

Clause 46: The laminate of any of clauses 31 to 45, wherein the interlayer comprises at least one layer of polyvinyl butyral (PVB).

Clause 47: The laminate of any of clauses 31 to 46, wherein the laminate is used in one or more of an architectural transparency or a vehicle transparency.

Clause 48: The laminate of any of clauses 31 to 46, wherein the laminate is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

Clause 49: A method of reducing visible light transmittance in a glass sheet comprising melting a glass batch to provide a pool of molten glass and cooling the molten glass batch to yield a molten glass, wherein the glass comprises 1.65 to 3 weight percent total iron expressed as Fc203, preferably 1.7 to 2.4 weight percent total iron, or even more preferably greater than 2.0 to 2.15 weight percent total iron, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5); flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath.

Clause 50: The method of clause 49, wherein the glass comprises a redox ratio of at least 0.12 and at most 0.32.

Clause 51: The method of clause 49, wherein the glass comprises a redox ratio of at least 0.16 and at most 0.26, or even a redox of at least 0.17 and at most 0.25.

Clause 52: The method of any of clauses 49 to 51, wherein the glass further comprises 0.044 to 0.059 weight percent CoO.

Clause 53: The method of any of clauses 49 to 51, wherein the glass further comprises 0.0465 to 0.0565 weight percent CoO.

Clause 54: The method of any of clauses 49 to 51, wherein the glass further comprises 0.049 to 0.054 weight percent CoO.

Clause 55: The method of any of clauses 49 to 54, wherein the glass further comprises 0.004 to 0.02 weight percent selenium, preferably 0.005 to 0.018 weight percent selenium, or even more preferably 0.006 to 0.008 weight percent selenium.

Clause 56: The method of any of clauses 49 to 55, wherein the glass further comprises 0.0005 to 0.07 weight percent Cr₂O₃, preferably 0.0009 to 0.06 weight percent Cr₂O₃, or even more preferably 0.001 to 0.05 weight percent Cr₂O₃, or even more preferably 0.038 to 0.044 weight percent Cr₂O₃. In another instance, the glass comprises 0.01 to 0.04 weight percent Cr₂O₃.

Clause 57: The method of any of clauses 49 to 56, wherein the glass further comprises 0.0005 to 0.03 weight percent CuO, preferably 0.0015 to 0.025 weight percent CuO, or even more preferably 0.002 to 0.02 weight percent CuO.

Clause 58: The method of any of clauses 49 to 57, wherein the glass further comprises 0.01 to 0.5 weight percent TiO₂, preferably 0.02 to 0.25 weight percent TiO₂, or even more preferably 0.03 to 0.1 weight percent TiO₂.

Clause 59: The method of any of clauses 49 to 58, wherein the glass has a neutral color as determined by the naked eye.

Clause 60: The method of any of clauses 49 to 59, wherein the glass has a T_{UV} of less than 8 percent at a glass thickness of 3.85 mm, or preferably the glass has a T_{UV} of less than 6 percent at a glass thickness of 3.85 mm, or even more preferably the glass has a T_{UV} of less than 4 percent at a glass thickness of 3.85 mm.

Clause 61: The method of any of clauses 49 to 60, wherein the glass has a visible light transmission (“T_{LA}”) of less than 5 percent at a glass thickness of 3.85 mm, or preferably the glass has a visible light transmission (“T_{LA}”) of less than 4.5 percent at a glass thickness of 3.85 mm, or even more preferably the glass has a visible light transmission (“T_{LA}”) of less than 4 percent at a glass thickness of 3.85 mm.

Clause 62: The method of any of clauses 49 to 61, wherein the glass has a Solar Direct Transmittance (Te) of less than 12 percent at a glass thickness of 3.85 mm, or preferably the glass has a Solar Direct Transmittance (Te) of less than 11 percent at a glass thickness of 3.85 mm, or even more preferably the glass has a Solar Direct Transmittance (Te) of less than 10 percent at a glass thickness of 3.85 mm.

Clause 63: The method of any of the clauses 40 to 62, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm, preferably the glass has a visible light transmission (“T_{LA}”) of greater than 1 percent and equal to or less than 7 percent at a glass thickness of 3.85 mm via T_{LA} CIE Ilum “A” across wavelengths 380 nm to 780 nm, an a* in the range of −6 to 4, and a b* in the range of −5.5 to 12.5.

Clause 64: The method of any of the clauses 49 to 63, wherein the glass has an a* in the range of −5 to 1, or even an a* in the range of −4.5 to 0.5, and a b* in the range of −2 to 6, or even a b* in the range of 0 to 5.

Clause 65: The method of any of the clauses 49 to 64, wherein the glass has an L* in the range of 10 to 35, preferably 13 to 28, or even more preferably 15 to 26, or even still more preferably 15.5 to 25.5.

### DETAILED DESCRIPTION OF THE INVENTION

Unless otherwise indicated, all numbers expressing dimensions, physical characteristics, quantities of ingredients, reaction conditions, and so forth used in the specification and claims include the beginning and ending range values, and to encompass any and all subranges subsumed therein. For example, a stated range of “1 to 10” should be considered to include any and all subranges between (and inclusive of) the minimum value of 1 and the maximum value of 10.

Any reference to composition amounts, unless otherwise specified, is “by weight percent” based on the total weight of the final glass composition. The “total iron” content of the glass compositions disclosed herein is expressed in terms of Fe₂O₃ in accordance with standard analytical practice, regardless of the form actually present. Likewise, the amount of iron in the ferrous state is reported as FeO, even though it may not actually be present in the glass as FeO. The terms “redox”, “redox ratio”, or “iron redox ratio” mean the amount of iron in the ferrous state (expressed as FeO) divided by the amount of total iron (expressed as Fe₂O₃). The “sulfur” content of the glass compositions disclosed herein is expressed in terms of SO₃ in accordance with standard analytical practices, regardless of the form actually present.

As used herein, “visible transmittance” values are determined using the conventional CIE Illuminant A and a 2-degree observer angle. Those skilled in the art will understand that properties such as visible transmittance can be calculated at an equivalent standard thickness, e.g., 3.85 millimeters (mm), even though the actual thickness of a measured glass sample is different than the standard thickness.

All documents, such as, but not limited to, issued patents and patent applications, referred to herein are to be considered to be incorporated by reference in their entireties.

Iron can be found in glass in two different oxidation states—iron in the ferrous state (Fe²⁺, expressed as ferrous oxide, FeO), and iron in the ferric state (Fe³⁺, expressed as ferric oxide, Fe₂O₃).

$$Iron Redox Ratio = \frac{{Fe}^{2 +} ( as weight percent FeO )}{Total Fe ( as weight percent {Fe}_{2} {O}_{3} )}$$

The term “redox ratio” means the amount of iron in the ferrous state (expressed as FeO) divided by the amount of total iron (expressed as Fe₂O₃).

As will be appreciated by one of ordinary skill in the art, controlling redox of a glass composition is achieved by controlling the conditions under which the glass is made. Many such factors may affect redox. The concentration of reducing agents (such as carbon) and the concentration of oxidizing agents (such as sodium sulfate) may each affect redox. For example, sodium sulfate (Na₂SO₄) may be added as a raw material to the glass batch for bubble elimination, high temperature refinement, promotion of mass transport, dissolution of free silica at the surface of the glass, and lessening the number of solid inclusions. However, Na₂SO₄ has oxidizing properties, such that small amounts of carbon are usually added to the mixture in order to counteract undesired oxidation. Further, Na₂SO₄ is converted during the glass manufacturing process into SO₃, which has an inverse relationship with redox, while sulfur has as direct relationship with redox. Finally, melting conditions, such as varying oxygen excess and adjusting flame alignment during combustion in a furnace, may further affect redox.

In one aspect of the present invention, the present invention comprises a glass that has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5). The glass may have an L* in the range of 10 to 35, preferably 13 to 28, or even more preferably 15 to 26, or even still more preferably 15.5 to 25.5.

In another aspect, the invention further comprises 0.044 to 0.059 weight percent CoO; or between 0.0465 to 0.0565 weight percent CoO; or even between 0.049 to 0.054 weight percent CoO. The addition of CoO assists in neutralizing the color of the glass while simultaneously assisting in achieving a T_{LA} range of greater than 0 percent to 10 percent, or in the range of greater than 0 percent to less than 9 percent, or in the range of 0.5 percent to less than 8 percent, or in the range of 1 percent to less than 7 percent, or even in the range of 2 percent to less than 6 percent, or even in the range of 3 percent and equal to or less than 5 percent, or even in the range of 2 percent and equal to or less than 4 percent, at a glass thickness of 3.85 mm via T_{LA} CIE Ilum “A” across wavelengths 380 nm to 780 nm.

With regard to the weight percentages of various compounds added to the glass compositions disclosed herein, such additives are based on weight percentages which can alternatively be viewed as any stated weight percent of any desired additive where such weight percent is based on 100 parts by weight of a base glass composition.

According to the present invention, the following performance properties are measured as described below. The ultraviolet transmittance (T_{UV}) is measured over the wavelength range of 300 nm to 400 nm, using the ISO 13837 standard. Additionally, if applicable, the visible light transmittance is measured using C.I.E. standard illuminant “A” (T_{LA}) over the wavelength range 380 nm to 780 nm; the solar direct transmittance (Te) is measured over the wavelength range of 300 nm to 2500 nm, using the ISO 13837 standard; the infrared transmittance (T_{IR}) is measured over the wavelength range of 800 nm to 2500 nm, using the ISO 13837 standard; and the total solar energy transmittance (Tₜₛ) is measured using the ISO 13837 standard. If applicable, the T_{UV}, T_{IR,} and Tₜₛ transmittance data is calculated using Parry Moon air mass 1.5 direct solar irradiance data and integrated using the Trapezoidal Rule, as is known in the art.

Additionally, one or more of the color variables L*, at, and b* of the color system CIELAB 1976 are also calculated through the tristimulus values.

The glass may be melted and refined in a continuous, large-scale commercial glass melting operation. It may further be formed into flat glass sheets of varying thickness by the float method in which the molten glass is supported on a pool of molten metal, usually tin, as it assumes a ribbon shape and is cooled in a manner well known in the art.

It should be noted that in any of the methods disclosed herein, coal can be utilized in the batch chemistry for forming the various glasses disclosed herein. In another instance, the coal in the batch chemistry can be replaced at a one to one ratio with any other suitable alternative source of carbon including, but not limited to, graphite. Should this change be made, no other changes need to be made to the batch chemistry in any of the above embodiments. Additionally, should an electric furnace be used to process the batch chemistry, the amount of coal, or other carbon source, should be varied accordingly in light of the different processing environment present in an electric furnace to that of a gas furnace. In one non-limiting example, since the coal, or other carbon source, is considered a reducing agent, the amount of carbon used should be varied based on the nature of the atmospheric makeup and/or environment present in the furnace used to process a desired glass batch in accordance with any of the embodiments of the invention.

As is known in the art, glass recycling is an integral part of various types of glass production. As such, in some cases the present invention may make use of one or more sources of glass cullet (i.e., recycled glass material). As is known, there are two types of cullet-internal and external. Internal cullet is composed of defective products detected and rejected by a quality control process during the industrial process of glass manufacturing, transition phases of product changes (such as thickness and color changes) and production offcuts, while external cullet is waste glass that has been collected or reprocessed with the purpose of recycling. External cullet, which can be pre- or post-consumer, may be classified as waste. In some embodiments, the present invention can make use of any suitable type of cullet, be it internal or external cullet. Should a large amount of external cullet be added to any of the batch chemistries detailed above, the amount of Fe₂S additive should be adjusted accordingly if such external cullet is composed of more than 50 weight percent visually clear glass as opposed to glass that appears either visually green, or blue green.

As would be appreciated, the present invention is not limited to just a glass composition but rather to a glass composition that can be used to form various glass-containing items where one or more layers of a glass according to any of the embodiments disclosed herein are desirable. Such glass-containing items can include, but are not limited to, display screens, architectural, transparencies, vehicle transparencies, etc.

In another instance, the glass composition of the present invention can be used to form a transparency that can be used in any desired architectural or vehicle application be such transparency a monolithic (i.e., one layer) structure, a multilayered structure, or even a multi-layered laminated structure (e.g., a laminated vehicle transparency). It should be noted that any suitable layered, or even non-layered, structure can be formed so as to contain at least one glass layer of the present invention. Since such structures are known to those of skill in the art, a detailed discussion herein is omitted for the sake of brevity.

In still another embodiment, the glass of the present invention can be coated with any one or more coatings known to those of skill in the art. Such coatings include, but are not limited to, one or more low-e coatings, one or more anti-reflective coatings, one or more solar control coatings (such as that have the ability to modify the amount of transmitted, reflected and absorbed solar radiation in the solar range comprised between 300 and 2500 nm), one or more low UV and/or IRC (near-IR) coatings, or combinations of any two or more thereof. Some non-limiting examples of suitable coatings are contained in U.S. Pat. No. 11,479,502 and WO 2014/058290, the disclosures of which are hereby incorporated by reference in their entireties.

Accordingly, in light of the above, in one embodiment of the invention, a glass comprises 64 to 75 weight percent SiO₂; 10 to 20 weight percent Na₂O; 5 to 15 weight percent CaO; 0 to 5 weight percent MgO; 0 to 3 weight percent Al₂O₃; 0 to 3 weight percent K₂O; 0 to 1 weight percent SO₃ (or even 0.1 to 0.35 weight percent SO₃); and 1.65 to 3 weight percent total iron, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5). The glass may have an L* in the range of 10 to 35, preferably 13 to 28, or even more preferably 15 to 26, or even still more preferably 15.5 to 25.5. In another instance, the glass further comprises a redox ratio of at least 0.12 and at most 0.32, or even a redox ratio of at least 0.13 and at most 0.31. In still another instance, the glass further comprises one or more of 0.044 to 0.059 weight percent CoO; 0.004 to 0.02 weight percent selenium; 0.0005 to 0.07 weight percent Cr₂O₃; 0.0005 to 0.03 weight percent CuO; and/or 0.01 to 0.5 weight percent TiO₂.

In one embodiment, the glass comprises 1.7 to 2.6 weight percent total iron, or 1.8 to 2.4 weight percent total iron, or 1.9 to 2.3 weight percent total iron, or even greater than 2.0 to 2.15 weight percent total iron.

In still another instance, the glass comprises 0.044 to 0.059 weight percent of CoO. In another instance, the glass can comprise 0.0465 to 0.0565 weight percent CoO. In still another instance, the glass can comprise 0.049 to 0.054 weight percent CoO.

In still another instance, the glass has a neutral color as determined by the naked eye. In still another instance, the glass has a T_{UV} of less than 8 percent at a glass thickness of 3.85 mm, or preferably the glass has a T_{UV} of less than 6 percent at a glass thickness of 3.85 mm, or even more preferably the glass has a T_{UV} of less than 4 percent at a glass thickness of 3.85 mm.

In still yet another instance, the glass has a visible light transmission (“T_{LA}”) of less than 5 percent at a glass thickness of 3.85 mm, or preferably the glass has a visible light transmission (“T_{LA}”) of less than 4.5 percent at a glass thickness of 3.85 mm, or even more preferably the glass has a visible light transmission (“T_{LA}”) of less than 4 percent at a glass thickness of 3.85 mm.

In still yet another instance, the glass has a Solar Direct Transmittance (Te) of less than 12 percent at a glass thickness of 3.85 mm, or preferably the glass has a Solar Direct Transmittance (Te) of less than 11 percent at a glass thickness of 3.85 mm, or even more preferably the glass has a Solar Direct Transmittance (Te) of less than 10 percent at a glass thickness of 3.85 mm.

In still yet another instance, the glass has a T_{IR} of 2 percent to 21 percent at a glass thickness of 3.85 mm, or preferably the glass has a T_{IR} of 3 percent to 20 percent at a glass thickness of 3.85 mm, or even more preferably the glass has a T_{IR} of 4 percent to 18 percent at a glass thickness of 3.85 mm, or even more preferably T_{IR} of 5 percent to 13 percent at a glass thickness of 3.85 mm.

In still yet another instance, the glass has a Te of 2 percent to 14 percent at a glass thickness of 3.85 mm, or preferably the glass has a Te of 3 percent to 13 percent at a glass thickness of 3.85 mm, or even more preferably the glass has a Te of 4 percent to 10 percent at a glass thickness of 3.85 mm, or even more preferably Te of 5 percent to 9 percent at a glass thickness of 3.85 mm.

In still yet another instance, the glass has a Tₜₛ of 26 percent to 38 percent at a glass thickness of 3.85 mm, or preferably the glass has a Tₜₛ of 28 percent to 36 percent at a glass thickness of 3.85 mm, or even more preferably the glass has a Tₜₛ of 29 percent to 33 percent at a glass thickness of 3.85 mm.

In still yet another instance, any of the glasses of the above embodiments can be used in one or more of an architectural transparency or a vehicle transparency. In still another instance, any of the glasses of the above embodiments can be used in one or more of an architectural transparency or a vehicle transparency, wherein such an architectural transparency and/or vehicle transparency comprises one or more low-e coatings, one or more anti-reflective coatings, one or more solar control coatings, one or more low UV and/or IRC coatings, or combinations of any two or more thereof.

Accordingly, in light of the above, in another embodiment of the invention, a method of making a glass using a conventional float non-vacuum glass system, comprises melting a glass batch to provide a pool of molten glass; flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath, wherein the glass comprises 64 to 75 weight percent SiO₂; 10 to 20 weight percent Na₂O; 5 to 15 weight percent CaO; 0 to 5 weight percent MgO; 0 to 3 weight percent Al₂O₃; 0 to 3 weight percent K₂O; 0 to 1 weight percent SO₃ (or even 0.1 to 0.35 weight percent SO₃); and 1.65 to 3 weight percent total iron expressed as Fe₂O₃, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5). The glass may have an L* in the range of 10 to 35, preferably 13 to 28, or even more preferably 15 to 26, or even still more preferably 15.5 to 25.5. In another instance, the glass further comprises a redox ratio of at least 0.12 and at most 0.32, or even a redox ratio of at least 0.13 and at most 0.31. In still another instance, the glass further comprises one or more of 0.044 to 0.059 weight percent CoO; 0.004 to 0.02 weight percent selenium; 0.0005 to 0.07 weight percent Cr₂O₃; 0.0005 to 0.03 weight percent CuO; and/or 0.01 to 0.5 weight percent TiO₂.

In still another instance, the glass of this method has a neutral color as determined by the naked eye. In still another instance, the glass of this method has a T_{UV} of less than 8 percent at a glass thickness of 3.85 mm, or preferably the glass has a T_{UV} of less than 6 percent at a glass thickness of 3.85 mm, or even more preferably the glass has a T_{UV} of less than 4 percent at a glass thickness of 3.85 mm.

In still yet another instance, the glass of this method has a visible light transmission (“T_{LA}”) of less than 5 percent at a glass thickness of 3.85 mm, or preferably the glass has a visible light transmission (“T_{LA}”) of less than 4.5 percent at a glass thickness of 3.85 mm, or even more preferably the glass has a visible light transmission (“T_{LA}”) of less than 4 percent at a glass thickness of 3.85 mm.

In still yet another instance, the glass of this method has a Solar Direct Transmittance (Te) of less than 12 percent at a glass thickness of 3.85 mm, or preferably the glass has a Solar Direct Transmittance (Te) of less than 11 percent at a glass thickness of 3.85 mm, or even more preferably the glass has a Solar Direct Transmittance (Te) of less than 10 percent at a glass thickness of 3.85 mm.

In still yet another instance, the glass of this method has a T_{IR} of 2 percent to 21 percent at a glass thickness of 3.85 mm, or preferably the glass has a T_{IR} of 3 percent to 20 percent at a glass thickness of 3.85 mm, or even more preferably the glass has a T_{IR} of 4 percent to 18 percent at a glass thickness of 3.85 mm, or even more preferably T_{IR} of 5 percent to 13 percent at a glass thickness of 3.85 mm.

In still yet another instance, the glass of this method has a Te of 2 percent to 14 percent at a glass thickness of 3.85 mm, or preferably the glass has a Te of 3 percent to 13 percent at a glass thickness of 3.85 mm, or even more preferably the glass has a Te of 4 percent to 10 percent at a glass thickness of 3.85 mm, or even more preferably Te of 5 percent to 9 percent at a glass thickness of 3.85 mm.

In still yet another instance, the glass of this method has a Tₜₛ of 26 percent to 38 percent at a glass thickness of 3.85 mm, or preferably the glass has a Tₜₛ of 28 percent to 36 percent at a glass thickness of 3.85 mm, or even more preferably the glass has a Tₜₛ of 29 percent to 33 percent at a glass thickness of 3.85 mm.

In still yet another instance, any of the glasses of the above methods can be used in one or more of an architectural transparency or a vehicle transparency. In still another instance, any of the glasses of the above methods can be used in one or more of an architectural transparency or a vehicle transparency, wherein such an architectural transparency and/or vehicle transparency comprises one or more low-e coatings, one or more anti-reflective coatings, one or more solar control coatings, one or more low UV and/or IRC coatings, or combinations of any two or more thereof.

Accordingly, in light of the above, in another embodiment of the invention, a laminate comprises a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; and an interlayer positioned between the first ply and the second ply, wherein at least one of the first ply or second ply is formed from a glass comprising 64 to 75 weight percent SiO₂; 10 to 20 weight percent Na₂O; 5 to 15 weight percent CaO; 0 to 5 weight percent MgO; 0 to 3 weight percent Al₂O₃; 0 to 3 weight percent K₂O; 0 to 1 weight percent SO₃ (or even 0.1 to 0.35 weight percent SO₃); and 1.65 to 3 weight percent total iron expressed as Fe₂O₃, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm (preferably the glass has a visible light transmission (“T_{LA}”) of greater than 1 percent and equal to or less than 7 percent, or even greater than 2 percent and equal to or less than 6 percent, or even greater than 3 percent and equal to or less than 5 percent, or even greater than 2 percent and equal to or less than 4 percent, at a glass thickness of 3.85 mm via T_{LA} CIE Ilum “A” across wavelengths 380 nm to 780 nm), an a* in the range of −8 to 4.5 (preferably an a* in the range of −6 to 4, or an a* in the range of −5 to 1, or even an a* in the range of −4.5 to 0.5), and a b* in the range of −12.5 to 15.5 (preferably a b* in the range of −5.5 to 12.5, or a b* in the range of −2 to 6, or even a b* in the range of 0 to 5). The glass may have an L* in the range of 10 to 35, preferably 13 to 28, or even more preferably 15 to 26, or even still more preferably 15.5 to 25.5. In another instance, the glass further comprises a redox ratio of at least 0.12 and at most 0.32, or even a redox ratio of at least 0.13 and at most 0.31. In still another instance, the glass further comprises one or more of 0.044 to 0.059 weight percent CoO; 0.004 to 0.02 weight percent selenium; 0.0005 to 0.07 weight percent Cr₂O₃; 0.0005 to 0.03 weight percent CuO; and/or 0.01 to 0.5 weight percent TiO₂.

In still another instance, at least one glass ply of this laminate has a neutral color as determined by the naked eye. In still another instance, at least one glass ply of this laminate has a T_{UV} of less than 8 percent at a glass thickness of 3.85 mm, or preferably the glass has a T_{UV} of less than 6 percent at a glass thickness of 3.85 mm, or even more preferably the glass has a T_{UV} of less than 4 percent at a glass thickness of 3.85 mm.

In still yet another instance, at least one glass ply of this laminate has a visible light transmission (“T_{LA}”) of less than 5 percent at a glass thickness of 3.85 mm, or preferably the glass has a visible light transmission (“T_{LA}”) of less than 4.5 percent at a glass thickness of 3.85 mm, or even more preferably the glass has a visible light transmission (“T_{LA}”) of less than 4 percent at a glass thickness of 3.85 mm.

In still yet another instance, at least one glass ply of this laminate has a Solar Direct Transmittance (Te) of less than 12 percent at a glass thickness of 3.85 mm, or preferably the glass has a Solar Direct Transmittance (Te) of less than 11 percent at a glass thickness of 3.85 mm, or even more preferably the glass has a Solar Direct Transmittance (Te) of less than 10 percent at a glass thickness of 3.85 mm.

In still yet another instance, at least one glass ply of this laminate has a T_{IR} of 2 percent to 21 percent at a glass thickness of 3.85 mm, or preferably the glass has a T_{IR} of 3 percent to 20 percent at a glass thickness of 3.85 mm, or even more preferably the glass has a T_{IR} of 4 percent to 18 percent at a glass thickness of 3.85 mm, or even more preferably T_{IR} of 5 percent to 13 percent at a glass thickness of 3.85 mm.

In still yet another instance, at least one glass ply of this laminate has a Te of 2 percent to 14 percent at a glass thickness of 3.85 mm, or preferably the glass has a Te of 3 percent to 13 percent at a glass thickness of 3.85 mm, or even more preferably the glass has a Te of 4 percent to 10 percent at a glass thickness of 3.85 mm, or even more preferably Te of 5 percent to 9 percent at a glass thickness of 3.85 mm.

In still yet another instance, at least one glass ply of this laminate has a Tₜₛ of 26 percent to 38 percent at a glass thickness of 3.85 mm, or preferably the glass has a Tₜₛ of 28 percent to 36 percent at a glass thickness of 3.85 mm, or even more preferably the glass has a Tₜₛ of 29 percent to 33 percent at a glass thickness of 3.85 mm.

In still yet another instance, any of the laminates of the above embodiments can be used in one or more of an architectural transparency or a vehicle transparency. In still another instance, any of the laminates of the above embodiments can be used in one or more of an architectural transparency or a vehicle transparency, wherein such an architectural transparency and/or vehicle transparency comprises one or more low-e coatings, one or more anti-reflective coatings, one or more solar control coatings, one or more low UV and/or IRC coatings, or combinations of any two or more thereof.

Regarding any numerical values disclosed in the specification (including any one or more numerical values from any one or more Examples in the Tables contained herein), be the individual values in one or more examples or from one or more portions of a numerical range, any of these individual numerical values can be combined with any other numerical value of a similar nature to form a new and/or non-disclosed range. That is, any individual redox numerical value can be combined with any other different redox numerical value to yield a new non-disclosed redox numerical range. Further, any individual numerical value from a given composition component, a given batch component, a given solar property, or even a given color property can be combined with any other different respective numerical value from a given composition component, a given batch component, a given solar property, or even a given color property to yield a new non-disclosed numerical range for one or more of a given composition component, a given batch component, a given solar property, or even a given color property.

As shown in the following Tables below, the following colorant formulations represent non-limiting embodiments for use in connection with any of the glass batch formulations described herein.

TABLE 1

| | | | | | | |
|---|---|---|---|---|---|---|
| Example | 1 | 2 | 3 | 4 | 5 | 6 |

Colorants - Percent by Weight

| | | | | | | |
|---|---|---|---|---|---|---|
| Fe₂O₃ | 2.00 | 2.11 | 2.19 | 2.12 | 2.02 | 2.15 |
| FeO | 0.634 | 0.533 | 0.544 | 0.540 | 0.320 | 0.388 |
| Redox | 0.317 | 0.253 | 0.249 | 0.255 | 0.159 | 0.180 |
| CoO | 0.0363 | 0.0375 | 0.0384 | 0.0378 | 0.0432 | 0.0448 |
| Se | 0.0052 | 0.0048 | 0.0055 | 0.0047 | 0.0107 | 0.0064 |
| TiO₂ | 0.068 | 0.061 | 0.061 | 0.060 | 0.063 | 0.062 |
| Cr₂O₃ | 0.0011 | 0.0009 | 0.0010 | 0.0010 | 0.0010 | 0.0010 |
| CuO | 0.0061 | 0.0061 | 0.0061 | 0.0061 | 0.0061 | 0.0061 |
| SO₃ | 0.157 | 0.177 | 0.203 | 0.203 | 0.264 | 0.237 |

Solar Properties 3.85 mm (%)

| | | | | | | |
|---|---|---|---|---|---|---|
| Ultraviolet | 0.8 | 0.7 | 0.6 | 0.9 | 0.4 | 0.7 |
| Transmittance (T_{UV}) | | | | | | |
| Visible Light | 3.6 | 4.1 | 3.6 | 4.7 | 3.8 | 4.0 |
| Transmittance | | | | | | |
| Iluminant A (T_{LA}) | | | | | | |
| Solar Direct | 3.3 | 4.5 | 4.1 | 4.7 | 9.4 | 7.5 |
| Transmittance (Te) | | | | | | |
| Infrared | 3.2 | 4.9 | 4.7 | 4.8 | 13.8 | 9.8 |
| Transmittance (T_{IR}) | | | | | | |
| Total Solar | 28.6 | 29.4 | 29.2 | 29.6 | 33.0 | 31.6 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 21.6 | 23.6 | 21.6 | 25.6 | 21.8 | 23.1 |
| a* | −0.2 | −0.8 | −0.4 | −2.4 | 3.1 | 0.6 |
| b* | 6.3 | 6.2 | 7.1 | 3.4 | 10.1 | 4.4 |
| X | 3.2 | 3.7 | 3.2 | 4.2 | 3.5 | 3.7 |
| Y | 3.4 | 4.0 | 3.4 | 4.6 | 3.5 | 3.8 |
| Z | 2.7 | 3.2 | 2.6 | 4.3 | 2.2 | 3.3 |

Iluminant C, 2° Obs

| | | | | | | |
|---|---|---|---|---|---|---|
| Dominant | 572.1 | 570.6 | 572.2 | 558.0 | 579.3 | 574.7 |
| Wavelength (nm) | | | | | | |
| Purity (%) | 19.4 | 17.5 | 21.3 | 8.2 | 31.8 | 13.8 |

TABLE 2

| | | | | | | |
|---|---|---|---|---|---|---|
| Example | 7 | 8 | 9 | 10 | 11 | 12 |

Colorants - Percent by Weight

| | | | | | | |
|---|---|---|---|---|---|---|
| Fe₂O₃ | 2.28 | 2.03 | 2.47 | 2.38 | 1.78 | 2.01 |
| FeO | 0.329 | 0.316 | 0.396 | 0.401 | 0.250 | 0.312 |
| Redox | 0.145 | 0.156 | 0.160 | 0.169 | 0.141 | 0.155 |
| CoO | 0.0459 | 0.0435 | 0.0491 | 0.0480 | 0.0430 | 0.0460 |
| Se | 0.0119 | 0.0062 | 0.0028 | 0.0058 | 0.0101 | 0.0093 |
| TiO₂ | 0.063 | 0.073 | 0.066 | 0.079 | 0.058 | 0.053 |
| Cr₂O₃ | 0.0008 | 0.0018 | 0.0011 | 0.0025 | 0.0736 | 0.0674 |
| CuO | 0.0120 | 0.0120 | 0.0120 | 0.0120 | 0.0060 | 0.0060 |
| SO₃ | 0.228 | 0.220 | 0.187 | 0.251 | 0.243 | 0.245 |

Solar Properties 3.85 mm (%)

| | | | | | | |
|---|---|---|---|---|---|---|
| Ultraviolet | 0.1 | 0.4 | 0.4 | 0.4 | 0.5 | 0.4 |
| Transmittance (T_{UV}) | | | | | | |
| Visible Light | 2.4 | 4.0 | 3.4 | 3.5 | 3.6 | 3.1 |
| Transmittance | | | | | | |
| Iluminant A (T_{LA}) | | | | | | |
| Solar Direct | 8.1 | 9.5 | 6.9 | 6.8 | 11.9 | 8.9 |
| Transmittance (Te) | | | | | | |
| Infrared | 13.2 | 14.1 | 9.4 | 9.3 | 19.7 | 14.2 |
| Transmittance (T_{IR}) | | | | | | |
| Total Solar | 32.1 | 33.1 | 31.2 | 31.1 | 34.8 | 32.7 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 15.8 | 22.6 | 21.2 | 21.4 | 21.1 | 19.5 |
| a* | 4.1 | 1.6 | −1.4 | −1.5 | 0.5 | −0.6 |
| b* | 15.3 | 9.6 | 4.6 | 5.4 | 13.6 | 11.5 |
| X | 2.1 | 3.6 | 3.0 | 3.1 | 3.1 | 2.7 |
| Y | 2.1 | 3.7 | 3.3 | 3.3 | 3.3 | 2.9 |
| Z | 0.8 | 2.5 | 2.8 | 2.8 | 1.7 | 1.6 |

Iluminant C, 2° Obs

| | | | | | | |
|---|---|---|---|---|---|---|
| Dominant | 579.9 | 577.0 | 568.0 | 568.6 | 574.4 | 572.6 |
| Wavelength (nm) | | | | | | |
| Purity (%) | 53.6 | 28.7 | 13.3 | 15.5 | 41.1 | 36.0 |

TABLE 3

| | | | | | | |
|---|---|---|---|---|---|---|
| Example | 13 | 14 | 15 | 16 | 17 | 18 |

Colorants - Percent by Weight

| | | | | | | |
|---|---|---|---|---|---|---|
| Fe₂O₃ | 2.14 | 2.07 | 2.21 | 2.11 | 2.36 | 2.29 |
| FeO | 0.357 | 0.412 | 0.462 | 0.495 | 0.538 | 0.676 |
| Redox | 0.167 | 0.199 | 0.209 | 0.234 | 0.227 | 0.295 |
| CoO | 0.0493 | 0.0471 | 0.0482 | 0.0481 | 0.0515 | 0.0505 |
| Se | 0.0029 | 0.0039 | 0.0079 | 0.0067 | 0.0059 | 0.0030 |
| TiO₂ | 0.061 | 0.061 | 0.054 | 0.057 | 0.060 | 0.062 |
| Cr₂O₃ | 0.0649 | 0.0611 | 0.0009 | 0.0009 | 0.0009 | 0.0011 |
| CuO | 0.0060 | 0.0060 | 0.0060 | 0.0060 | 0.0060 | 0.0060 |
| SO₃ | 0.184 | 0.190 | 0.222 | 0.207 | 0.213 | 0.173 |

Solar Properties 3.85 mm (%)

| | | | | | | |
|---|---|---|---|---|---|---|
| Ultraviolet | 3.7 | 1.2 | 0.4 | 0.6 | 0.4 | 1.2 |
| Transmittance (T_{UV}) | | | | | | |
| Visible Light | 6.2 | 4.2 | 2.4 | 2.8 | 2.3 | 3.5 |
| Transmittance | | | | | | |
| Iluminant A (T_{LA}) | | | | | | |
| Solar Direct | 9.8 | 6.8 | 5.0 | 4.8 | 3.9 | 3.4 |
| Transmittance (Te) | | | | | | |
| Infrared | 11.0 | 8.7 | 6.9 | 6.0 | 4.9 | 2.7 |
| Transmittance (T_{IR}) | | | | | | |
| Total Solar | 33.3 | 31.1 | 29.8 | 29.6 | 29.0 | 28.6 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 31.4 | 24.4 | 16.7 | 18.9 | 16.5 | 22.8 |
| a* | −6.6 | −4.9 | 1.8 | 0.5 | −0.8 | −4.1 |
| b* | −8.5 | 2.1 | 7.3 | 3.8 | 3.5 | −6.9 |
| X | 5.9 | 3.7 | 2.2 | 2.6 | 2.1 | 3.3 |
| Y | 6.8 | 4.2 | 2.2 | 2.7 | 2.2 | 3.8 |
| Z | 9.9 | 4.1 | 1.6 | 2.4 | 2.0 | 5.4 |

Iluminant C, 2° Obs

| | | | | | | |
|---|---|---|---|---|---|---|
| Dominant | 484.3 | 519.9 | 577.5 | 573.8 | 567.7 | 483.1 |
| Wavelength (nm) | | | | | | |
| Purity (%) | 23.1 | 4.9 | 26.9 | 13.5 | 12.0 | 21.7 |

TABLE 4

| | | | | | | |
|---|---|---|---|---|---|---|
| Example | 19 | 20 | 21 | 22 | 23 | 24 |

Colorants - Percent by Weight

| | | | | | | |
|---|---|---|---|---|---|---|
| Fe₂O₃ | 1.89 | 1.88 | 1.98 | 1.98 | 2.09 | 1.82 |
| FeO | 0.281 | 0.237 | 0.293 | 0.260 | 0.466 | 0.432 |
| Redox | 0.149 | 0.127 | 0.148 | 0.132 | 0.223 | 0.237 |
| CoO | 0.0488 | 0.0477 | 0.0494 | 0.0500 | 0.0506 | 0.0479 |
| Se | 0.0072 | 0.0131 | 0.0078 | 0.0107 | 0.0053 | 0.0019 |
| TiO₂ | 0.058 | 0.057 | 0.058 | 0.058 | 0.0600 | 0.074 |
| Cr₂O₃ | 0.0961 | 0.0884 | 0.0896 | 0.0887 | 0.0388 | 0.0334 |
| CuO | 0.0060 | 0.0060 | 0.0060 | 0.0060 | 0.0040 | 0.0040 |
| SO₃ | 0.242 | 0.287 | 0.257 | 0.272 | 0.225 | 0.132 |

Solar Properties 3.85 mm (%)

| | | | | | | |
|---|---|---|---|---|---|---|
| Ultraviolet | 0.9 | 0.7 | 0.9 | 0.7 | 1.9 | 4.0 |
| Transmittance (T_{UV}) | | | | | | |
| Visible Light | 3.8 | 4.1 | 3.9 | 3.7 | 4.4 | 7.3 |
| Transmittance | | | | | | |
| Iluminant A (T_{LA}) | | | | | | |
| Solar Direct | 10.5 | 12.8 | 10.1 | 11.4 | 6.1 | 8.6 |
| Transmittance (Te) | | | | | | |
| Infrared | 16.5 | 20.8 | 15.6 | 18.3 | 6.7 | 8.0 |
| Transmittance (T_{IR}) | | | | | | |
| Total Solar | 33.8 | 35.5 | 33.5 | 34.4 | 30.6 | 32.5 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 22.7 | 23.7 | 23.1 | 22.2 | 25.8 | 34.4 |
| a* | −4.7 | −4.0 | −5.1 | −4.2 | −4.6 | −6.4 |
| b* | 6.9 | 8.9 | 6.3 | 7.2 | −5.3 | −12.4 |
| X | 3.2 | 3.5 | 3.3 | 3.1 | 4.1 | 7.1 |
| Y | 3.7 | 4.0 | 3.8 | 3.6 | 4.7 | 8.2 |
| Z | 2.9 | 2.8 | 3.1 | 2.7 | 6.2 | 13.1 |

Iluminant C, 2° Obs

| | | | | | | |
|---|---|---|---|---|---|---|
| Dominant | 559.6 | 564.8 | 556.7 | 561.9 | 485.7 | 481.9 |
| Wavelength (nm) | | | | | | |
| Purity (%) | 18.2 | 23.6 | 16.0 | 19.4 | 17.0 | 28.5 |

TABLE 5

| | | | | | | |
|---|---|---|---|---|---|---|
| Example | 25 | 26 | 27 | 28 | 29 | 30 |

Colorants - Percent by Weight

| | | | | | | |
|---|---|---|---|---|---|---|
| Fe₂O₃ | 2.05 | 2.05 | 2.11 | 2.08 | 1.73 | 1.78 |
| FeO | 0.402 | 0.379 | 0.352 | 0.353 | 0.288 | 0.260 |
| Redox | 0.196 | 0.184 | 0.167 | 0.170 | 0.167 | 0.146 |
| CoO | 0.0530 | 0.0525 | 0.0535 | 0.0524 | 0.0470 | 0.0493 |
| Se | 0.0070 | 0.0070 | 0.0090 | 0.0084 | 0.0131 | 0.0170 |
| TiO₂ | 0.059 | 0.059 | 0.060 | 0.060 | 0.056 | 0.055 |
| Cr₂O₃ | 0.0401 | 0.0394 | 0.0409 | 0.0394 | 0.0431 | 0.0449 |
| CuO | 0.0040 | 0.0040 | 0.0040 | 0.0040 | 0.0050 | 0.0050 |
| SO₃ | 0.211 | 0.222 | 0.250 | 0.249 | 0.261 | 0.284 |

Solar Properties 3.85 mm (%)

| | | | | | | |
|---|---|---|---|---|---|---|
| Ultraviolet | 0.7 | 0.6 | 0.4 | 0.4 | 0.8 | 0.2 |
| Transmittance (T_{UV}) | | | | | | |
| Visible Light | 2.7 | 2.6 | 2.3 | 2.3 | 3.9 | 2.7 |
| Transmittance | | | | | | |
| Iluminant A (T_{LA}) | | | | | | |
| Solar Direct | 6.3 | 6.8 | 7.3 | 7.3 | 10.5 | 10.9 |
| Transmittance (Te) | | | | | | |
| Infrared | 9.0 | 10.1 | 11.4 | 11.4 | 16.0 | 18.3 |
| Transmittance (T_{IR}) | | | | | | |
| Total Solar | 30.8 | 31.2 | 31.5 | 31.5 | 33.8 | 34.1 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 18.3 | 18.0 | 16.1 | 16.3 | 22.6 | 17.5 |
| a* | −1.2 | −0.4 | 0.5 | 0.7 | −0.5 | 1.8 |
| b* | 3.3 | 5.0 | 7.3 | 7.7 | 6.2 | 12.6 |
| X | 2.4 | 2.4 | 2.0 | 2.1 | 3.5 | 2.4 |
| Y | 2.6 | 2.5 | 2.1 | 2.2 | 3.7 | 2.4 |
| Z | 2.3 | 2.1 | 1.5 | 1.5 | 2.9 | 1.2 |

Iluminant C, 2° Obs

| | | | | | | |
|---|---|---|---|---|---|---|
| Dominant | 564.9 | 570.7 | 574.3 | 574.8 | 571.3 | 576.7 |
| Wavelength (nm) | | | | | | |
| Purity (%) | 11.0 | 17.3 | 26.8 | 28.1 | 18.6 | 42.6 |

TABLE 6

| | | | | | | |
|---|---|---|---|---|---|---|
| Example | 31 | 32 | 33 | 34 | 35 | 36 |

Colorants - Percent by Weight

| | | | | | | |
|---|---|---|---|---|---|---|
| Fe₂O₃ | 1.91 | 1.91 | 2.02 | 1.99 | 2.09 | 2.09 |
| FeO | 0.304 | 0.301 | 0.500 | 0.354 | 0.371 | 0.385 |
| Redox | 0.160 | 0.157 | 0.248 | 0.178 | 0.178 | 0.184 |
| CoO | 0.0521 | 0.0513 | 0.0532 | 0.0525 | 0.0543 | 0.0549 |
| Se | 0.0132 | 0.0121 | 0.0057 | 0.0081 | 0.0090 | 0.0094 |
| TiO₂ | 0.056 | 0.055 | 0.062 | 0.060 | 0.062 | 0.061 |
| Cr₂O₃ | 0.0487 | 0.0491 | 0.0501 | 0.0488 | 0.0520 | 0.0508 |
| CuO | 0.0050 | 0.0050 | 0.0050 | 0.0050 | 0.0050 | 0.0050 |
| SO₃ | 0.273 | 0.279 | 0.192 | 0.223 | 0.239 | 0.231 |

Solar Properties 3.85 mm (%)

| | | | | | | |
|---|---|---|---|---|---|---|
| Ultraviolet | 0.2 | 0.3 | 1.3 | 0.4 | 0.4 | 0.3 |
| Transmittance (T_{UV}) | | | | | | |
| Visible Light | 2.0 | 2.6 | 3.1 | 2.4 | 2.2 | 2.0 |
| Transmittance | | | | | | |
| Iluminant A (T_{LA}) | | | | | | |
| Solar Direct | 8.6 | 9.1 | 4.7 | 7.2 | 6.6 | 6.2 |
| Transmittance (Te) | | | | | | |
| Infrared | 14.6 | 14.8 | 5.7 | 11.5 | 10.5 | 9.8 |
| Transmittance (T_{IR}) | | | | | | |
| Total Solar | 32.5 | 32.8 | 29.6 | 31.4 | 31.0 | 30.7 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 14.4 | 17.4 | 21.0 | 16.8 | 16.2 | 15.0 |
| a* | 1.7 | 0.0 | −4.1 | −0.8 | −1.6 | −0.9 |
| b* | 12.3 | 9.0 | −1.7 | 7.3 | 5.6 | 6.8 |
| X | 1.8 | 2.3 | 2.8 | 2.1 | 2.0 | 1.8 |
| Y | 1.8 | 2.4 | 3.2 | 2.3 | 2.1 | 1.9 |
| Z | 0.9 | 1.5 | 3.8 | 1.6 | 1.7 | 1.4 |

Iluminant C, 2° Obs

| | | | | | | |
|---|---|---|---|---|---|---|
| Dominant | 576.6 | 573.4 | 491.9 | 571.0 | 567.6 | 570.6 |
| Wavelength (nm) | | | | | | |
| Purity (%) | 45.7 | 30.7 | 10.2 | 25.1 | 19.5 | 25.0 |

TABLE 7

| | | | | | | |
|---|---|---|---|---|---|---|
| Example | 37 | 38 | 39 | 40 | 41 | 42 |

Colorants - Percent by Weight

| | | | | | | |
|---|---|---|---|---|---|---|
| Fe₂O₃ | 1.85 | 1.90 | 1.88 | 1.89 | 1.86 | 1.86 |
| FeO | 0.330 | 0.308 | 0.333 | 0.324 | 0.307 | 0.288 |
| Redox | 0.179 | 0.162 | 0.177 | 0.171 | 0.165 | 0.155 |
| CoO | 0.0486 | 0.0494 | 0.0491 | 0.0494 | 0.0488 | 0.0495 |
| Se | 0.0093 | 0.0094 | 0.0065 | 0.0083 | 0.0136 | 0.0153 |
| TiO₂ | 0.060 | 0.062 | 0.061 | 0.061 | 0.060 | 0.061 |
| Cr₂O₃ | 0.0383 | 0.0396 | 0.0394 | 0.0398 | 0.0388 | 0.0392 |
| CuO | 0.0070 | 0.0070 | 0.0070 | 0.0070 | 0.0070 | 0.0070 |
| SO₃ | 0.259 | 0.254 | 0.221 | 0.244 | 0.275 | 0.283 |

Solar Properties 3.85 mm (%)

| | | | | | | |
|---|---|---|---|---|---|---|
| Ultraviolet | 0.5 | 0.5 | 0.9 | 0.6 | 0.4 | 0.3 |
| Transmittance (T_{UV}) | | | | | | |
| Visible Light | 3.1 | 3.2 | 3.7 | 3.2 | 3.0 | 2.9 |
| Transmittance | | | | | | |
| Iluminant A (T_{LA}) | | | | | | |
| Solar Direct | 8.5 | 9.3 | 8.7 | 8.8 | 9.2 | 9.9 |
| Transmittance (Te) | | | | | | |
| Infrared | 13.0 | 14.5 | 12.7 | 13.4 | 14.6 | 16.0 |
| Transmittance (T_{IR}) | | | | | | |
| Total Solar | 32.3 | 33.0 | 32.5 | 32.6 | 32.9 | 33.3 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 19.8 | 20.2 | 22.2 | 20.3 | 19.2 | 18.5 |
| a* | −0.6 | −0.7 | −1.9 | −0.8 | 0.3 | 0.6 |
| b* | 7.1 | 6.9 | 3.7 | 6.3 | 9.4 | 10.2 |
| X | 2.8 | 2.8 | 3.3 | 2.9 | 2.7 | 2.5 |
| Y | 2.9 | 3.0 | 3.6 | 3.1 | 2.8 | 2.6 |
| Z | 2.2 | 2.3 | 3.2 | 2.4 | 1.8 | 1.6 |

Iluminant C, 2° Obs

| | | | | | | |
|---|---|---|---|---|---|---|
| Dominant | 571.6 | 571.3 | 562.5 | 570.7 | 574.2 | 574.8 |
| Wavelength (nm) | | | | | | |
| Purity (%) | 22.5 | 21.8 | 10.6 | 19.8 | 30.3 | 33.6 |

TABLE 8

| | | | | | | |
|---|---|---|---|---|---|---|
| Example | 43 | 44 | 45 | 46 | 47 | 48 |

Colorants - Percent by Weight

| | | | | | | |
|---|---|---|---|---|---|---|
| Fe₂O₃ | 1.95 | 1.98 | 2.15 | 2.10 | 2.18 | 2.18 |
| FeO | 0.289 | 0.383 | 0.460 | 0.338 | 0.334 | 0.392 |
| Redox | 0.148 | 0.193 | 0.214 | 0.161 | 0.153 | 0.180 |
| CoO | 0.0513 | 0.0514 | 0.0571 | 0.0566 | 0.0576 | 0.0582 |
| Se | 0.0139 | 0.0137 | 0.0052 | 0.0159 | 0.0126 | 0.0104 |
| TiO₂ | 0.062 | 0.061 | 0.064 | 0.059 | 0.061 | 0.061 |
| Cr₂O₃ | 0.0411 | 0.0419 | 0.0389 | 0.0374 | 0.0396 | 0.0393 |
| CuO | 0.0070 | 0.0070 | 0.0050 | 0.0050 | 0.0050 | 0.0050 |
| SO₃ | 0.291 | 0.264 | 0.193 | 0.288 | 0.274 | 0.267 |

Solar Properties 3.85 mm (%)

| | | | | | | |
|---|---|---|---|---|---|---|
| Ultraviolet | 0.4 | 0.8 | 1.0 | 0.2 | 0.7 | 0.5 |
| Transmittance (T_{UV}) | | | | | | |
| Visible Light | 2.9 | 3.0 | 2.6 | 1.7 | 2.2 | 2.1 |
| Transmittance | | | | | | |
| Iluminant A (T_{LA}) | | | | | | |
| Solar Direct | 9.9 | 6.9 | 5.1 | 7.2 | 7.6 | 6.1 |
| Transmittance (Te) | | | | | | |
| Infrared | 15.8 | 9.8 | 6.8 | 12.2 | 12.4 | 9.3 |
| Transmittance (T_{IR}) | | | | | | |
| Total Solar | 33.4 | 31.2 | 29.9 | 31.4 | 31.7 | 30.6 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 18.9 | 19.7 | 18.8 | 12.7 | 15.9 | 15.6 |
| a* | 0.1 | −1.2 | −2.8 | 1.3 | 0.2 | −1.0 |
| b* | 8.8 | 4.5 | −2.1 | 8.8 | 5.8 | 3.0 |
| X | 2.6 | 2.7 | 2.4 | 1.5 | 2.0 | 1.9 |
| Y | 2.7 | 2.9 | 2.7 | 1.5 | 2.1 | 2.0 |
| Z | 1.8 | 2.5 | 3.2 | 0.9 | 1.6 | 1.8 |

Iluminant C, 2° Obs

| | | | | | | |
|---|---|---|---|---|---|---|
| Dominant | 573.8 | 567.5 | 490.2 | 576.0 | 573.7 | 564.7 |
| Wavelength (nm) | | | | | | |
| Purity (%) | 28.6 | 14.3 | 9.6 | 35.8 | 21.4 | 11.3 |

TABLE 9

| | | | | | | |
|---|---|---|---|---|---|---|
| Example | 49 | 50 | 51 | 52 | 53 | 54 |

Colorants - Percent by Weight

| | | | | | | |
|---|---|---|---|---|---|---|
| Fe₂O₃ | 2.07 | 2.06 | 1.95 | 1.88 | 2.11 | 2.04 |
| FeO | 0.350 | 0.297 | 0.262 | 0.266 | 0.289 | 0.304 |
| Redox | 0.169 | 0.144 | 0.134 | 0.142 | 0.137 | 0.149 |
| CoO | 0.0521 | 0.0511 | 0.0497 | 0.0488 | 0.0512 | 0.0500 |
| Se | 0.0092 | 0.0144 | 0.0178 | 0.0080 | 0.0138 | 0.0138 |
| TiO₂ | 0.060 | 0.060 | 0.059 | 0.059 | 0.069 | 0.067 |
| Cr₂O₃ | 0.0364 | 0.0359 | 0.0345 | 0.0321 | 0.0380 | 0.0371 |
| CuO | 0.0070 | 0.0070 | 0.0070 | 0.0070 | 0.0070 | 0.0070 |
| SO₃ | 0.225 | 0.271 | 0.304 | 0.230 | 0.282 | 0.295 |

Solar Properties 3.85 mm (%)

| | | | | | | |
|---|---|---|---|---|---|---|
| Ultraviolet | 0.8 | 0.4 | 0.2 | 1.9 | 0.3 | 0.4 |
| Transmittance (T_{UV}) | | | | | | |
| Visible Light | 3.4 | 3.0 | 2.7 | 4.6 | 2.7 | 2.9 |
| Transmittance | | | | | | |
| Iluminant A (T_{LA}) | | | | | | |
| Solar Direct | 8.0 | 9.6 | 10.9 | 11.7 | 9.7 | 9.3 |
| Transmittance (Te) | | | | | | |
| Infrared | 11.5 | 15.2 | 18.2 | 17.7 | 15.8 | 14.6 |
| Transmittance (T_{IR}) | | | | | | |
| Total Solar | 32.0 | 33.2 | 34.1 | 34.7 | 33.2 | 32.9 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 21.4 | 19.5 | 17.8 | 24.9 | 17.9 | 18.9 |
| a* | −2.5 | −0.9 | 1.0 | 0.0 | −0.1 | 0.1 |
| b* | 2.4 | 7.8 | 12.5 | 6.1 | 9.7 | 8.5 |
| X | 3.0 | 2.7 | 2.4 | 4.2 | 2.4 | 2.6 |
| Y | 3.4 | 2.9 | 2.5 | 4.4 | 2.5 | 2.7 |
| Z | 3.2 | 2.1 | 1.3 | 3.6 | 1.5 | 1.9 |

Iluminant C, 2° Obs

| | | | | | | |
|---|---|---|---|---|---|---|
| Dominant | 550.8 | 571.4 | 575.5 | 573.5 | 573.6 | 573.7 |
| Wavelength (nm) | | | | | | |
| Purity (%) | 6.5 | 24.4 | 41.2 | 17.1 | 32.0 | 27.7 |

TABLE 10

| | | | | | | |
|---|---|---|---|---|---|---|
| Example | 55 | 56 | 57 | 58 | 59 | 60 |

Colorants - Percent by Weight

| | | | | | | |
|---|---|---|---|---|---|---|
| Fe₂O₃ | 2.21 | 2.10 | 2.15 | 2.16 | 2.15 | 2.14 |
| FeO | 0.307 | 0.298 | 0.274 | 0.272 | 0.264 | 0.283 |
| Redox | 0.139 | 0.142 | 0.127 | 0.126 | 0.123 | 0.132 |
| CoO | 0.0528 | 0.0512 | 0.0510 | 0.0511 | 0.0510 | 0.0507 |
| Se | 0.0155 | 0.0148 | 0.0057 | 0.0051 | 0.0063 | 0.0040 |
| TiO₂ | 0.070 | 0.068 | 0.010 | 0.010 | 0.010 | 0.010 |
| Cr₂O₃ | 0.0400 | 0.0389 | 0.0899 | 0.0899 | 0.0894 | 0.0891 |
| CuO | 0.0070 | 0.0070 | 0.0070 | 0.0070 | 0.0070 | 0.0070 |
| SO₃ | 0.283 | 0.304 | 0.232 | 0.238 | 0.235 | 0.218 |

Solar Properties 3.85 mm (%)

| | | | | | | |
|---|---|---|---|---|---|---|
| Ultraviolet | 0.2 | 0.2 | 1.6 | 1.8 | 1.4 | 2.1 |
| Transmittance (T_{UV}) | | | | | | |
| Visible Light | 2.3 | 2.3 | 5.0 | 5.2 | 4.8 | 5.5 |
| Transmittance | | | | | | |
| Iluminant A (T_{LA}) | | | | | | |
| Solar Direct | 8.7 | 9.1 | 11.6 | 11.8 | 11.9 | 11.6 |
| Transmittance (Te) | | | | | | |
| Infrared | 14.3 | 15.1 | 17.3 | 17.3 | 18.2 | 16.5 |
| Transmittance (T_{IR}) | | | | | | |
| Total Solar | 32.5 | 32.8 | 34.6 | 34.7 | 34.8 | 34.5 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 15.8 | 16.0 | 27.2 | 27.9 | 26.4 | 28.9 |
| a* | 0.3 | 0.8 | −7.2 | −7.6 | −6.7 | −8.1 |
| b* | 10.3 | 11.2 | 1.3 | 0.3 | 2.5 | −1.2 |
| X | 2.0 | 2.0 | 4.3 | 4.6 | 4.1 | 4.9 |
| Y | 2.1 | 2.1 | 5.1 | 5.4 | 4.9 | 5.8 |
| Z | 1.2 | 1.1 | 5.2 | 5.7 | 4.7 | 6.5 |

Iluminant C, 2° Obs

| | | | | | | |
|---|---|---|---|---|---|---|
| Dominant | 574.5 | 575.3 | 503.6 | 498.9 | 515.4 | 494.5 |
| Wavelength (nm) | | | | | | |
| Purity (%) | 36.2 | 39.2 | 7.5 | 9.3 | 6.0 | 12.3 |

TABLE 11

| | | | | | | |
|---|---|---|---|---|---|---|
| Example | 61 | 62 | 63 | 64 | 65 | 66 |

Colorants - Percent by Weight

| | | | | | | |
|---|---|---|---|---|---|---|
| Fe₂O₃ | 2.21 | 2.09 | 2.03 | 1.99 | 2.18 | 2.17 |
| FeO | 0.608 | 0.498 | 0.375 | 0.371 | 0.316 | 0.319 |
| Redox | 0.275 | 0.239 | 0.185 | 0.186 | 0.145 | 0.147 |
| CoO | 0.0526 | 0.0513 | 0.0509 | 0.0501 | 0.0520 | 0.0517 |
| Se | 0.0039 | 0.0067 | 0.0096 | 0.0105 | 0.0060 | 0.0048 |
| TiO₂ | 0.067 | 0.068 | 0.065 | 0.065 | 0.010 | 0.010 |
| Cr₂O₃ | 0.0378 | 0.0386 | 0.0369 | 0.0360 | 0.0410 | 0.0408 |
| CuO | 0.0070 | 0.0070 | 0.0070 | 0.0070 | 0.0070 | 0.0070 |
| SO₃ | 0.157 | 0.197 | 0.240 | 0.241 | 0.228 | 0.222 |

Solar Properties 3.85 mm (%)

| | | | | | | |
|---|---|---|---|---|---|---|
| Ultraviolet | 0.9 | 0.6 | 0.3 | 0.2 | 1.3 | 1.8 |
| Transmittance (T_{UV}) | | | | | | |
| Visible Light | 2.6 | 2.4 | 2.1 | 1.9 | 4.3 | 5.0 |
| Transmittance | | | | | | |
| Iluminant A (T_{LA}) | | | | | | |
| Solar Direct | 3.3 | 4.3 | 6.5 | 6.5 | 9.8 | 10.2 |
| Transmittance (Te) | | | | | | |
| Infrared | 3.6 | 5.9 | 10.3 | 10.5 | 13.9 | 13.7 |
| Transmittance (T_{IR}) | | | | | | |
| Total Solar | 28.5 | 29.3 | 30.9 | 30.9 | 33.3 | 33.5 |
| Transmittance (Tₜₛ) | | | | | | |

Color Transmitted Iluminant D65 10 Obs (ASTM E308) 3.85 mm

| | | | | | | |
|---|---|---|---|---|---|---|
| L* | 19.0 | 17.1 | 15.1 | 13.8 | 25.0 | 27.4 |
| a* | −4.7 | −2.3 | 0.4 | 1.6 | −3.2 | −4.3 |
| b* | −1.1 | 4.3 | 8.9 | 10.9 | −1.0 | −3.7 |
| X | 2.4 | 2.1 | 1.8 | 1.7 | 4.0 | 4.6 |
| Y | 2.7 | 2.3 | 1.9 | 1.7 | 4.4 | 5.2 |
| Z | 3.1 | 2.0 | 1.2 | 0.9 | 5.0 | 6.5 |

Iluminant C, 2° Obs

| | | | | | | |
|---|---|---|---|---|---|---|
| Dominant | 493.8 | 562.0 | 574.3 | 576.6 | 493.9 | 487.4 |
| Wavelength (nm) | | | | | | |
| Purity (%) | 10.2 | 13.9 | 32.7 | 41.9 | 6.5 | 12.9 |

TABLE 12

| | | |
|---|---|---|
| Example | 67 | 68 |

Colorants - Percent by Weight

| | | |
|---|---|---|
| Fe₂O₃ | 2.18 | 2.15 |
| FeO | 0.329 | 0.318 |
| Redox | 0.151 | 0.148 |
| CoO | 0.0518 | 0.0513 |
| Se | 0.0041 | 0.0032 |
| TiO₂ | 0.010 | 0.011 |
| Cr₂O₃ | 0.0412 | 0.0405 |
| CuO | 0.0070 | 0.0070 |
| SO₃ | 0.217 | 0.205 |

Solar Properties 3.85 mm (%)

| | | |
|---|---|---|
| Ultraviolet | 2.0 | 2.4 |
| Transmittance (T_{UV}) | | |
| Visible Light | 5.2 | 5.7 |
| Transmittance | | |
| Iluminant A (T_{LA}) | | |
| Solar Direct | 9.9 | 10.7 |
| Transmittance (Te) | | |
| Infrared | 13.0 | 13.7 |
| Transmittance (T_{IR}) | | |
| Total Solar | 33.4 | 33.9 |
| Transmittance (Tₜₛ) | | |

Color Transmitted Iluminant D65 10 Obs (ASTM E308) 3.85 mm

| | | |
|---|---|---|
| L* | 28.3 | 29.7 |
| a* | −4.9 | −5.1 |
| b* | −5.3 | −6.5 |
| X | 4.9 | 5.4 |
| Y | 5.6 | 6.1 |
| Z | 7.3 | 8.4 |

Iluminant C, 2° Obs

| | | |
|---|---|---|
| Dominant | 485.9 | 484.8 |
| Wavelength (nm) | | |
| Purity (%) | 16.5 | 18.5 |

Regarding the various solar properties in Tables 1 to 12 above, note the following T_{UV} values are determined via ISO 13837, air mass 1.5, wavelength range 300 nm to 400 nm; Te values are determined via ISO 13837 air mass 1.5, wavelength range 300 nm to 2500 nm; T_{IR} values are determined via ISO 13837 air mass 1.5, wavelength range 800 nm to 2500 nm; Tₜₛ values are determined via ISO 13837, v=4 m/seg; and T_{LA} values are determined via CIE Ilum “A” wavelength range 380 nm to 780 nm.

Reaching the proposed properties for a glass composition, according to the scope of the invention, other variations may be applied without departing from what is described in the claims that follow. Accordingly, the particular embodiments described in detail herein are illustrative only and are not limiting as to the scope of the invention, which is to be given the full breadth of the appended claims and any and all equivalents thereof.

What is claimed is:

1. A glass comprising:

| | |
|---|---|
| SiO₂ | 64 to 75 weight percent; |
| Na₂O | 10 to 20 weight percent; |
| CaO | 5 to 15 weight percent; |
| MgO | 0 to 5 weight percent; |
| Al₂O₃ | 0 to 3 weight percent; |
| K₂O | 0 to 3 weight percent; |
| SO₃ | 0 to 1 weight percent; |
| total iron as Fe₂O₃ | 1.65 to 3 weight percent, |
| CoO | 0.044 to 0.059 weight percent, |
| Cr₂O₃ | 0.0005 to 0.07 weight percent, |
| CuO | 0.0005 to 0.03 weight percent, and |
| a redox ratio | of at least 0.12 and at most 0.32. |

2. The glass of claim 1, wherein the glass has a visible light transmission (“T_{LA}”) of greater than 0 percent and equal to or less than 8 percent at a glass thickness of 3.85 mm via T_{LA} CIE Ilum “A” across wavelengths 380 nm to 780 nm.

3. The glass of claim 1, wherein the glass has an a* in the range of −8 to 4.5, and a b* in the range of −12.5 to 15.5.

4. The glass of claim 1, wherein the glass further comprises 0.004 to 0.02 weight percent selenium.

5. The glass of claim 1, wherein the glass further comprises 0.044 to 0.059 weight percent CoO.

6. The glass of claim 1, wherein the glass further comprises 0.01 to 0.5 weight percent TiO₂.

7. The glass of claim 1, wherein the glass is used in one or more of an architectural transparency or a vehicle transparency.

8. The glass of claim 1, wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

9. The glass of claim 1, wherein the redox ratio is at least 0.16 and at most 0.32.

10. The glass of claim 1, wherein the redox ratio is at least 0.17 and at most 0.25.

11. The glass of claim 1, wherein the CoO is in the range of 0.0465 to 0.0565 weight percent.

12. The glass of claim 4, wherein the selenium is in the range of 0.005 to 0.018 weight percent.

13. The glass of claim 1, wherein the Cr₂O₃ is in the range of 0.001 to 0.05 weight percent.

14. The glass of claim 1, wherein the Cr₂O₃ is in the range of 0.01 to 0.04 weight percent.

15. The glass of claim 1, wherein the CuO is in the range of 0.0015 to 0.025 weight percent.

16. The glass of claim 1, wherein the TiO₂ is in the range of 0.02 to 0.025 weight percent.

17. The glass of claim 1, wherein the glass further comprises a coating selected from the group consisting of a low-emissivity coating, an anti-reflective coating, a solar control coating, a low UV coating, a IRC coating, and a combination thereof.

18. A method of making a glass using a conventional float non-vacuum glass system, comprising:
melting a glass batch to provide a pool of molten glass;
flowing the pool of molten glass onto a molten tin bath;
moving the molten glass on the surface of the molten tin bath, while controllably cooling the molten glass and applying forces to the molten glass to provide a glass of a desired thickness; and
removing the glass from the molten tin bath,
wherein the glass comprises:

| | |
|---|---|
| SiO₂ | 64 to 75 weight percent; |
| Na₂O | 10 to 20 weight percent; |
| CaO | 5 to 15 weight percent; |
| MgO | 0 to 5 weight percent; |
| Al₂O₃ | 0 to 3 weight percent; |
| K₂O | 0 to 3 weight percent; |
| SO₃ | 0 to 1 weight percent; |
| total iron as Fe₂O₃ | 1.65 to 3 weight percent, |
| CoO | 0.044 to 0.059 weight percent, |
| Cr₂O₃ | 0.0005 to 0.07 weight percent, |
| CuO | 0.0005 to 0.03 weight percent, and |
| a redox ratio | of at least 0.12 and at most 0.32. |

19. A laminate comprising:
a first ply comprising a first surface and a second surface opposite the first surface, wherein the first surface comprises an outer surface of the laminate;
a second ply comprising a third surface adjacent the second surface and a fourth surface opposite the third surface, wherein the fourth surface comprises an inner surface of the laminate; and
an interlayer positioned between the first ply and the second ply,
wherein at least one of the first ply or second ply is formed from a glass comprising:

| | |
|---|---|
| SiO₂ | 64 to 75 weight percent; |
| Na₂O | 10 to 20 weight percent; |
| CaO | 5 to 15 weight percent; |
| MgO | 0 to 5 weight percent; |
| Al₂O₃ | 0 to 3 weight percent; |
| K₂O | 0 to 3 weight percent; |
| SO₃ | 0 to 1 weight percent; |
| total iron as Fe₂O₃ | 1.65 to 3 weight percent, |
| CoO | 0.044 to 0.059 weight percent, |
| Cr₂O₃ | 0.0005 to 0.07 weight percent, |
| CuO | 0.0005 to 0.03 weight percent, and |
| a redox ratio | of at least 0.12 and at most 0.32. |

20. The laminate of claim 19, wherein a second surface of the first ply or a third surface of the second ply comprises a coating selected from the group consisting of a low-emissivity coating, an anti-reflective coating, a solar control coating, a low UV coating, a IRC coating, and a combination thereof.
